(19) United States
(12) Patent Application Publication
(10) Pub. No.: US 2013/0021138 A1
(43) Pub. Date: Jan. 24, 2013

(54) METHOD OF EVALUATING STRUCTURAL INTEGRITY OF A VEHICLE COMPONENT WITH RADIO FREQUENCY IDENTIFICATION TAGS AND SYSTEM FOR SAME

(71) Applicants: Hesham A. Ezzat, Troy, MI (US); Pei-Chung Wang, Shanghai (CN); Marcel R. Cannon, Romeo, MI (US); Kangping Wang, Troy, MI (US)

(72) Inventors: Hesham A. Ezzat, Troy, MI (US); Pei-Chung Wang, Shanghai (CN); Marcel R. Cannon, Romeo, MI (US); Kangping Wang, Troy, MI (US)

(73) Assignee: GM GLOBAL TECHNOLOGY OPERATIONS LLC, Detroit, MI (US)

(21) Appl. No.: 13/186,834

(22) Filed: Jul. 20, 2011

(51) Int. Cl. G06K 7/01

(52) U.S. Cl. 340/10.1

(57) ABSTRACT

A method of evaluating the structural integrity of a component such as a vehicle component includes receiving signals from radio frequency identification (RFID) tags embedded in the component. The signals received are then compared to stored data indicative of sets of signals and that is correlated with different physical conditions of the component. A level of structural integrity of the component is then determined based on the comparison. The RFID tags may be wirelessly activated by an RFID reader to generate the signals. The comparison and determination may be carried out by a processor of an RFID reader. A system for evaluating the structural integrity of a component is also provided.

### TECHNICAL FIELD

The invention relates to a method of evaluating the structural integrity of a vehicle component, such as a fiber-reinforced composite component or a bonded joint, using radio frequency identification tags embedded in the component, and a system for evaluating the structural integrity of such a vehicle component.

### BACKGROUND

Automotive vehicles frequently incorporate composite components, such as fiber-reinforced plastics, in order to reduce overall vehicle weight. Similarly, load-bearing joints in modern vehicles are sometimes bonded with an adhesive, which reduces weight in comparison to the use of bolts or other fasteners. Irregularities in production of fiber-reinforced plastics can lead to delamination between the layers of the composite material, which may not be apparent upon visual inspection. Improperly applied adhesive in a bonded joint is also difficult to detect with visual techniques. Following an impact event, visual inspection to evaluate the structural integrity of composite components and of bonded joints may not be informative as the damage may be internal only. Known methods of evaluating vehicles for structural integrity include ultra-sonic, thermal imaging, and x-ray techniques. These techniques, while nondestructive to the component, may be time intensive and expensive. Furthermore, interpretation of the results of these techniques may be difficult.

### SUMMARY

Simple and accurate evaluation of the structural integrity of a component, such as a vehicle component, is enabled by the use of radio frequency identification (RFID) tags and an RFID reader configured to determine a physical condition of the component relative to a preferred physical condition (e.g., a condition with no damage or imperfection or with an acceptable amount of damage or imperfection). Specifically, a method of evaluating the structural integrity of a component includes receiving signals from radio frequency identification (RFID) tags attached to the component. In some embodiments, the RFID tags are embedded in the component. The signals received are then compared to stored data indicative of sets of signals that are correlated with different physical conditions of the component. A level of structural integrity of the component is determined based on the comparison. The RFID tags may be passive RFID tags that are wirelessly activated by the RFID reader to generate the signals. In other embodiments, active or other types of RFID tags may be used. The comparison and determination may be carried out by a processor of the RFID reader. The processor may have stored data indicative of sets of signals provided by RFID tags in different components of the same type that have been purposely damaged or mismanufactured in different ways to establish different physical conditions. The stored data effectively establishes a calibrated scale of structural integrity so that the existence and magnitude of any damage or structural defect may be indicated when the signals of the RFID tags in the component are compared to the stored data.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a system for evaluating the structural integrity of a vehicle component shown in partial cross-sectional view that is a bonded joint with RFID tags embedded in adhesive at the joint, and showing an RFID reader scanning the vehicle component;

FIG. 2 is a schematic illustration in partial cross-sectional view of a vehicle component like that of FIG. 1 with some adhesive and RFID tags missing from the joint;

FIG. 3 is a schematic illustration in partial cross-sectional view of a vehicle component like that of FIGS. 1 and 2 with more adhesive and RFID tags missing from the joint;

FIG. 4 is a schematic illustration in partial cross-sectional view of a vehicle component like that of FIGS. 1-3 with impact damage;

FIG. 5 is a schematic illustration in side view of a different vehicle component that is a fiber-reinforced composite with RFID tags embedded in adhesive between layers of the composite;

FIG. 6 is a schematic illustration in side view of the same type of vehicle component as shown in FIG. 5 with some adhesive and an RFID tag missing between two of the composite layers;

FIG. 7 is a schematic illustration in side view of the same type of vehicle component as shown in FIGS. 5 and 6 with more adhesive and more RFID tags missing between two of the composite layers;

FIG. 8 is a schematic illustration in side view of the same type of vehicle component as shown in FIGS. 5-7 with some adhesive and an RFID tag missing between two of the composite layers and with impact damage;

FIG. 9 is a flow diagram of a method of evaluating structural integrity of the vehicle components of FIGS. 1-8 including an algorithm carried out by a processor of the RFID reader;

FIG. 10 is a flow diagram of the algorithm carried out by the processor of the RFID reader; and

FIG. 11 is a schematic plan view of one of the RFID tags of FIG. 1.

### DETAILED DESCRIPTION

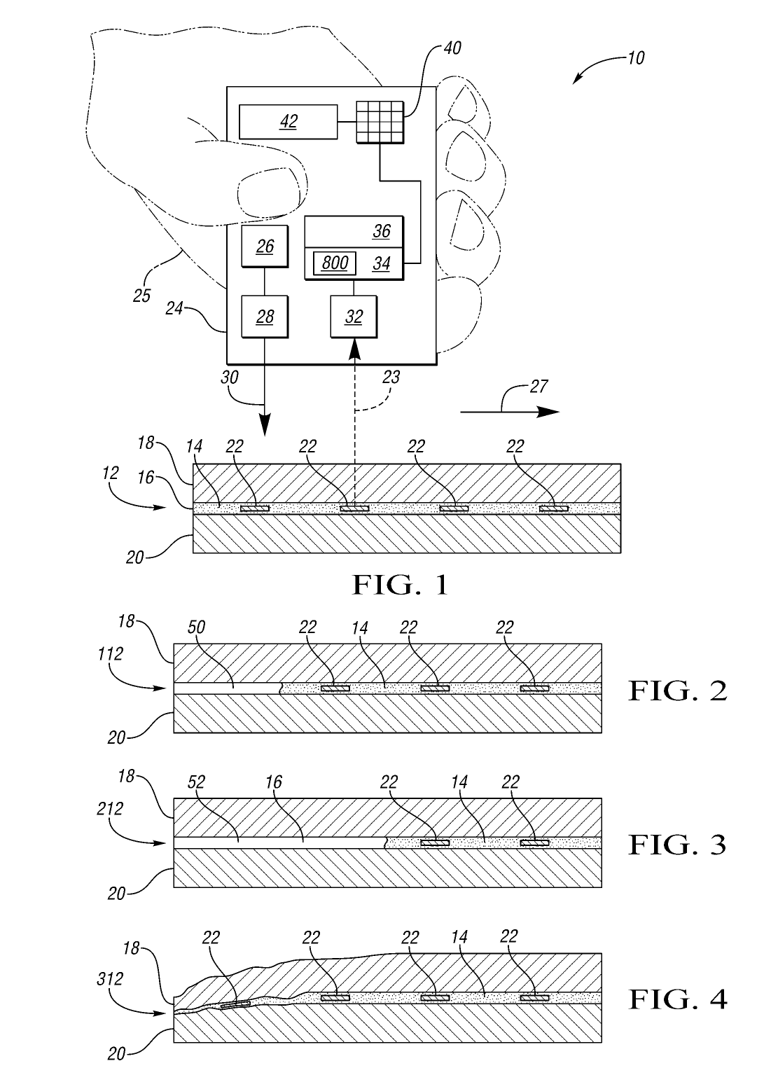

Referring to the drawings, wherein like reference numbers refer to like components throughout the several views, FIG. 1 shows a system 10 for evaluating structural integrity of a vehicle component 12. Although the system 10 is described with respect to a vehicle component 12, the system 10 may be used to evaluate the structural integrity of other types of structural components as well. The vehicle component 12 is vehicle body structure bonded with adhesive 14 at a bond line 16. The vehicle component 12 has a first portion 18 and a second portion 20 adhered at the bond line 16. The vehicle component 12 is body structure and may be, by way of non-limiting example, motor compartment rails, a shock tower, rear compartment rails, or a B-pillar. For example, a B-pillar typically has an inner pillar portion and an outer pillar portion, which are represented by the first portion 18 and the second portion 20, respectively.

RFID tags 22 are dispensed such that they are embedded within the vehicle component 12 during the joining process. The RFID tags 22 are spaced in a predetermined arrangement along the bond line 16 within the adhesive 14. The component 12 of FIG. 1 with the RFID tags 22 spaced as shown represents a preferred physical condition of the component 12, as the adhesive 14 is substantially across the entire bond line 16 and the RFID tags 22 are spaced across the entire bond line 16. In other embodiments, fewer or more RFID tags 22 may be used, or RFID tags 22 may be dispensed only in areas of the component 12 deemed to be of greater importance for structural integrity, such as for load-bearing purposes. The RFID tags 22 are shown as rectangular in shape in the cross-sectional and side views of FIGS. 1-8. RFID tags with other shapes, such as round RFID tags, may be used within the scope of the claimed invention.

The RFID tags 22 each generate a signal 23 (one indicated) with a characteristic radio frequency when activated. As shown in FIG. 11, each RFID tag 22 may be a passive tag having a microchip 29 storing identifying data and an antenna 31, but without a power source. Such passive RFID tags 22 are activated by the reader 24. In other embodiments, active RFID tags having their own power source may be used.

The system 10 also includes an RFID reader 24, shown in FIG. 1, that may be manually held by a user 25 adjacent to the component 12 and moved generally parallel to a surface of the component 12, such as in the direction of arrow 27, without contacting the component 12. The RFID reader 24 wirelessly activates the RFID tags 22, and receives and analyzes the signals 23 as further explained below. A different arrangement of the RFID tags 22 will affect the frequency of the signals 23 received. This is utilized to carry out a nondestructive evaluation of the structural integrity of the vehicle component 12. The evaluation may be conducted after manufacture of the component 12 is complete, after the component 12 is installed on a vehicle, for routine maintenance checks of the structural integrity of the vehicle component 12, or for an evaluation of structural integrity following an impact event. Because the scan is performed remotely, such as but not limited to at a distance from one to five feet from the component 12, no manipulation or contact with the component 12 is required, and the evaluation is nondestructive (i.e., does not affect the physical condition of the vehicle component 12).

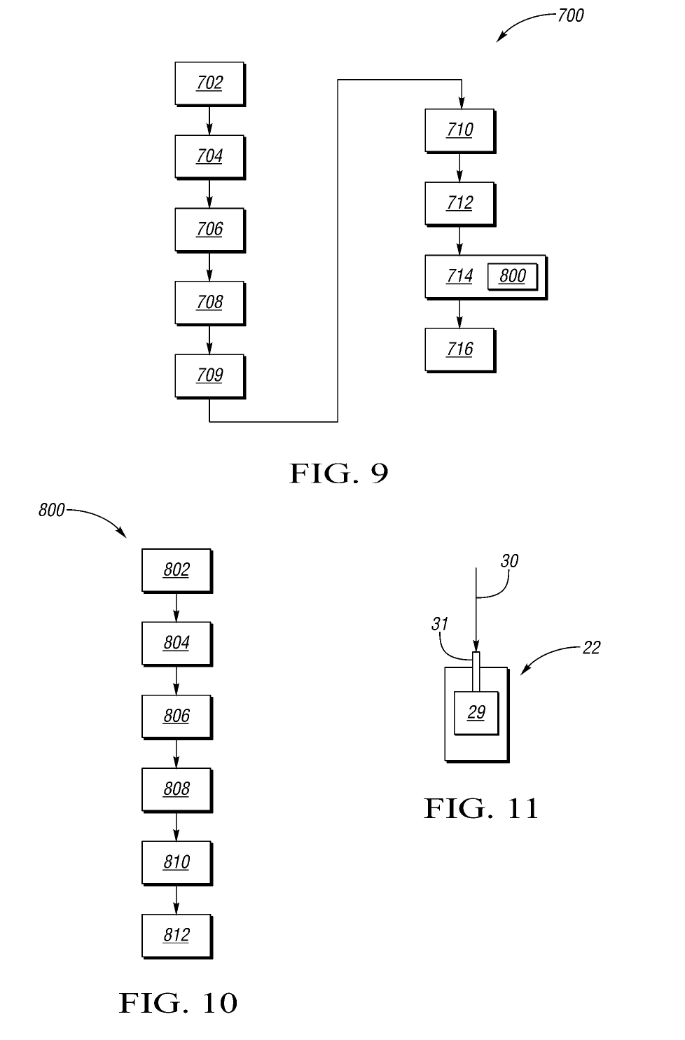

The RFID reader 24 has a power source 26 operatively connected to a transmitter 28 that transmits an electromagnetic field 30. The electromagnetic field 30 is received by the antenna 31 (see FIG. 11) of the RFID tag 22 and electric power is generated in the microchip 29 of each RFID tag 22 as the RFID reader 24 passes over the RFID tag 22. The RFID tag 22 then generates the signal 23 in the form of a radio wave that is read by a receiver 32 of the RFID reader 24. The set of signals 23 from the RFID tags 22 are interpreted by a processor 34 of the RFID reader 24. The processor 34 has a stored algorithm 800, discussed with respect to FIGS. 9 and 10, that evaluates a physical condition of the vehicle component 12 by comparing the set of signals 23 to stored data indicative of previous sets of signals that is stored in a database in a memory 36 of the RFID reader 24. The data indicative of previous sets of signals are received from components of the same type as the vehicle component 12, e.g., other B-pillars for the same vehicle model, each having a different physical condition, i.e., a different level of structural integrity. The stored database is a correlation of the sets of signals 23 received and the different physical conditions of the vehicle components 12 from which they have been received. Accordingly, the set of signals 23 received from the component 12 is indicative of the structural integrity of the component 12 when the processor 34 compares the signals to the stored data indicative of sets of signals corresponding with different physical conditions.

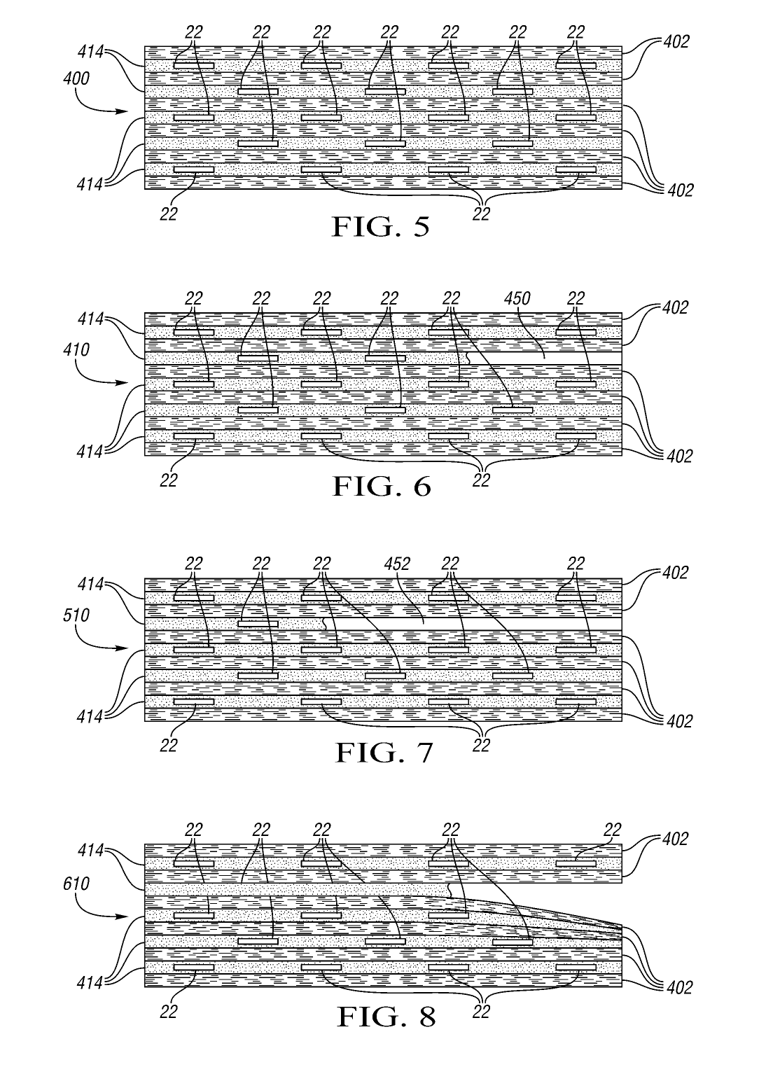

The reader 24 has an input mechanism 40 such as a keyboard that allows a user 25 to choose from a selection of different types of vehicle components listed on a display screen 42 in order to set the reader 24 for scanning of a particular type of vehicle component. The database in the memory 36 of the RFID reader 24 may thus have different sets of stored signals for different types of vehicle components. By way of non-limiting example, the RFID reader 24 may have stored data indicative of sets of signals corresponding with different levels of structural integrity of the vehicle component 12, shown with respect to vehicle components 112, 212, 312, all of the same type, in FIGS. 2-4. The RFID reader 24 may have additional stored data indicative of sets of signals corresponding with other vehicle components, such as vehicle components 400, 410, 510, 610 in FIGS. 5-8, all of which are fiber-reinforced composite vehicle components, each of the same type, such as for a vehicle panel. In this manner, the same RFID reader 24 may be used for evaluating the structural integrity of many different vehicle components.

To carry out the evaluation of structural integrity, the processor 34 must be programmed with an algorithm 800 that indicates the structural integrity of a scanned component by comparing the signature of the signals 23 generated by the scan to stored data indicative of sets of signals representing different physical conditions of like vehicle components 12. To establish the stored data indicative of sets of signals stored in the memory 36 and used by the processor 34 to determine the structural integrity of the vehicle component 12, multiple vehicle components 12 of the same type are purposefully manufactured with different physical conditions, such as missing adhesive or missing RFID tags 22, or are manufactured with a preferred physical condition, such as the component 12 of FIG. 1, and are then subjected to physical damage, such as by forceful impact or otherwise, to alter the physical condition.

The stored data indicative of each set of signals is a signature scale, i.e. a collection of all of the signals from each RFID tag 22 in the order received by the RFID reader 24 as the RFID reader 24 scans the component 12. Because the RFID tags 22 are not in the same relative locations in physically-impacted and damaged vehicle components 12, or because one or more RFID tags 22 may be altogether missing in mismanufactured or damaged vehicle components 12, the signals 23 generated by the vehicle components with these different physical conditions will have a different scale or signature (i.e., the radio frequency of one or more of the signals 23 will be different than the radio frequency of an RFID tag 22 in a position without damage, or, if an RFID tag 22 is missing, no signal will be generated when the reader 24 passes over the area of the missing RFID tag 22, causing a different signature).

Several vehicle components of the same type as vehicle component 12 are shown in FIGS. 2-4. These components are purposefully manufactured with different physical conditions so that they will each generate a different set of signals 23. For example, in FIG. 2, vehicle component 112 includes vehicle portions 18, 20 substantially identical to those in FIG. 1, but both adhesive 14 and one of the RFID tags 22 are missing from a portion 50 of the bond line 16. In other words, RFID tags 22 and adhesive 16 are dispensed over only a portion of the bond line 16. The vehicle component 112 is scanned with the RFID reader 24 of FIG. 1 and the data indicative of signals 23 generated are stored in the database of memory 36 along with an indication of a level of structural integrity of the component 112 (i.e., with data indicating that the left-most RFID tag 22 is missing and a certain portion of the bond line 16 is not covered with adhesive). The data stored for each signal 23 may be a numerical value corresponding with the frequency of the signal 23.

The vehicle component 212 of FIG. 3 is also the same type of component as vehicle components 12 and 112, but the RFID tags 22 and adhesive 14 are dispensed so that the adhesive 14 is missing from an even larger portion 52 of the bond line 16, and an additional RFID tag 22 is also missing. The vehicle component 212 is scanned with RFID reader 24 and data indicative of the signals generated are stored in the database of memory 36 with an indication of a level of structural integrity of the component 212 (i.e., with data indicating that two RFID tags 22 are missing and a certain portion 52 of the bond line 16 is not covered with adhesive.

In FIG. 4, vehicle component 312 is the same type of component as vehicle components 12, 112 and 212, with RFID tags 22 and adhesive 14 dispensed in the same manner as in vehicle component 12 of FIG. 1, but the component 312 has been subjected to physical impact to deform portion 18 and, to a lesser extent, portion 20. This damage may move and possibly deform the left-most RFID tag 22, causing the signal 23 generated by that RFID tag 22 to have a different frequency than if the component 312 were not damaged, and instead had a preferred physical condition, such as the physical condition of vehicle component 12 of FIG. 1. The vehicle component 312 is scanned with the RFID reader 24 and data indicative of the signals generated is stored in the database of memory 36 with an indication of a level of structural integrity of the component 312 (i.e., with data indicating that the left-most RFID tag 22 as well as the first portion 18 are physically damaged).

Referring to FIGS. 5-8, the same RFID reader 24 of FIG. 1 can be used to evaluate the structural integrity of a different type of vehicle component 400. The vehicle component 400 is a fiber-reinforced composite with multiple layers 402 of fiber-reinforced composite material (e.g., composite panels or structural sections) held together with adhesive 414 between each pair of adjacent layers 402. Although described as a vehicle component 400, within the scope of the claimed invention, the component 400 may be any type of fiber-reinforced composite component. The fiber-reinforced material may include any type of fibers suitable for the application, such as but not limited to glass fibers, ceramic fibers, carbon fibers, nano-steel fibers, etc. RFID tags 22 are dispensed in the adhesive 414 between each pair of layers so that they are embedded in the component 400. In this embodiment, the RFID tags 22 are dispensed in a staggered pattern in adjacent layers 402. In other embodiments, fewer or more RFID tags 22 may be used. For example, to reduce cost, RFID tags 22 may be dispensed only in areas of the component 400 deemed to be of greater importance for structural integrity, such as for load-bearing purposes.

Several vehicle components of the same type as vehicle component 400 are shown in FIGS. 6-8. These components are purposefully manufactured with different physical conditions so that the RFID tags 22 embedded therein will each generate a different set of signals. For example, in FIG. 6, vehicle component 410 includes layers 402 substantially identical to those in FIG. 5, but both adhesive 414 and one of the RFID tags 22 are missing from a portion 450 between two of the layers 402. In other words, RFID tags 22 and adhesive 414 are dispensed over only a portion of the area between the adjacent layers 402. The vehicle component 410 is scanned with the RFID reader 24 of FIG. 1 and data indicative of the signals generated by the RFID tags 22 are stored in the database of memory 36 with an indication of a level of structural integrity of the component 410 (i.e., with data indicating that one of the RFID tags 22 is missing and a certain portion 450 of area between the second and third composite layers 402 is not covered with adhesive.

The vehicle component 510 of FIG. 7 is also the same type of component as vehicle components 400 and 410, but the RFID tags 22 and adhesive 414 are dispensed so that the adhesive 414 is missing from an even larger portion 452 between adjacent layers 402 and an additional RFID tag 22 is also missing. The vehicle component 510 is scanned with the RFID reader 24 of FIG. 1 and the signals generated by the RFID tags 22 are stored in the database of memory 36 with an indication of a level of structural integrity of the component 510 (i.e., with data indicating that two of the RFID tags 22 are missing between the second and third layers 402 and the portion 452 between the layers 402 is not covered with adhesive 414).

In FIG. 8, vehicle component 610 is the same type of component as vehicle components 400, 410 and 510, with RFID tags 22 and adhesive 414 dispensed in the same manner as in vehicle component 400 of FIG. 5. However, vehicle component 610 has been subjected to physical impact to deform a portion of the component 610, with the second and third layers 402 becoming partially delaminated from one another, and with an RFID tag 22 in the delaminated area missing. The vehicle component 610 is scanned with the RFID reader 24 of FIG. 1 and the signals 23 generated by the RFID tags 22 are stored in the database of memory 36 with an indication of a level of structural integrity of the component 610 (i.e., with data indicating that two of the layers 402 are partially delaminated from one another and that an RFID tag 22 is missing).

Referring to FIG. 9, a flow diagram shows a method 700 of evaluating the structural integrity of a component, such as vehicle component 12, 112, 212, 312, 400, 410, 510 or 610. The flow diagram shows the portion of method 700 carried out by a vehicle manufacturer, vehicle servicer, or another party. The method 700 also includes the algorithm 800 carried out by the processor 34 of the RFID reader 24, shown in greater detail in the flow diagram of FIG. 10. The method 700 begins with blocks 702-709, which may be carried out by the same party that carries out blocks 710-716, described below, or by a different party.

In blocks 702-708, the database of memory 36 of the RFID reader 24 of FIG. 1 is created, and the data indicative of the sets of signals 23 from the different vehicle components 12, 112, 212, 312, 400, 410, 510 and 610 of FIGS. 1-8 is correlated with different levels of structural integrity. In block 702, RFID tags 22 are dispensed such that they are embedded in the components 12, 112, 212, 312, 400, 410, 510 and 610. In block 704, some of the components may be physically damaged, such as component 312 of FIG. 4 and component 610 of FIG. 8. In block 706, each component is then scanned with an RFID reader 24 to generate a set of signals 23 from the RFID tags 22 in the component. Because each component scanned has a unique physical condition with a different level of structural integrity, in block 708, data indicative of each set of signals is stored in the database of memory 36 of the RFID reader 24 as a separate data set.

Steps 702 to 708 can be repeated as many times as desired with different types of vehicle components, or with the same types of vehicle components manufactured differently or subjected to impact or the like to establish different physical conditions. In this manner, the database of memory 36 of the RFID reader 24 can be continually updated to allow evaluation of the structural integrity of additional components, such as components of new product lines. In block 709, the stored data indicative of sets of signals for each different type of component are stored as a different data group within the database of memory 36 to allow for user selection of the type of component to be scanned, as discussed below.

After blocks 702-709 have been completed, the RFID reader 24 is now configured with the stored data necessary to allow it to be used to evaluate the structural integrity of different vehicle components. Accordingly, a user 25 of FIG. 1 wishing to evaluate the structural integrity of a vehicle component using the RFID reader 24 begins with block 710, powering the RFID reader 24, such as by turning on the power source 26, which may be a battery that is turned on by a switch (not shown). In block 712, the method 700 continues with the user 25 selecting the type of vehicle component to be evaluated. The selection is made using the input mechanism 40 and the user display 42, which will initially list all of the vehicle component types that may be evaluated using the RFID reader 24. For purposes of discussion of the remainder of the method 700, it will be assumed that the component to be evaluated is component 212 of FIG. 3. Accordingly, assuming component 212 is a B-pillar, the user 25 will use the input mechanism 40 and the user display 42 to select “B-pillar” for a particular model of vehicle in block 710.

Once the selection is made, the user 25 then wirelessly scans the component 212 in block 714, using the RFID reader 24 by moving the RFID reader 24 remotely, generally parallel to a surface of the component 212, although the movement is not limited to this manner. In the embodiment shown, the RFID tags 22 are passive, and the RFID reader 24 wirelessly activates the RFID tags 22 with the electromagnetic field 30 of the transmitter 28 to generate the signals 23. The algorithm 800 will cause the RFID reader 24 to indicate the level of structural integrity of the component 212, as further described below. This allows the user 25 to determine in block 716 how to further process the vehicle component 212. For example, if the physical condition of the component 212 indicated by the reader 24 is determined to be too different from the preferred physical condition of FIG. 1, then in block 716, the component 212 may be further processed by either repairing or scrapping the component 212. If the physical condition of the component 212 is considered to be acceptable for the purposes served by the component 212, then the further processing of block 716 may be approving the component 212 for installation if the method 700 is being carried out during vehicle manufacture, or approving the component 212 for further use if the method 700 is being carried out during vehicle servicing or following an impact event. If the physical condition of the component 212 is deemed too different from the preferred physical condition of component 12 of FIG. 1, then the further processing of block 716 may include repairing or replacing the component 12.

Referring to FIG. 10, the algorithm 800 carried out by the processor 34 during the scanning block 714 begins with block 802 in which input information is received indicating that the vehicle component scanned is the first type of vehicle component, i.e., a B-pillar in the case of component 212. The input information is the component type selected by the user 25 via the input mechanism 40 in block 712. With the type of component known according to block 802, in block 804 the processor 34 can then access data indicative of the correct sets of signals stored in the database of memory 36 that correspond with the type of vehicle component selected. For example, if vehicle component 212 is being scanned, in block 804, the stored data indicative of the sets of signals from the scan of components 12, 112, 212 and 312 are accessed by the processor 34. The signals 23 generated by the RFID tags 22 of the component 212 are received by the receiver 32 in block 806. In block 808, the signals 23 received are compared to the data indicative of the stored set of signals accessed in block 804. In block 810, a level of structural integrity of the component 212 is determined by matching the signals 23 received by scanning component 212 to the most closely corresponding stored data indicative of set of signals and the corresponding level of structural integrity. This level of structural integrity determined is then provided as an output in block 812, such as by displaying a structural integrity value assigned to the physical condition on the screen 42. The user 25 then has the relevant information to proceed with block 716 of the method 700 as described above.

The system 10 of FIG. 1 and the method 700 and algorithm 800 described above allow for relatively quick, inexpensive and accurate evaluation of the structural integrity of a variety of vehicle components in a nondestructive manner.

While the best modes for carrying out the invention have been described in detail, those familiar with the art to which this invention relates will recognize various alternative designs and embodiments for practicing the invention within the scope of the appended claims.

1. A method of evaluating structural integrity of a component comprising:
receiving signals from radio frequency identification (RFID) tags attached to the component;
comparing the signals received to stored data indicative of sets of signals that are correlated with different physical conditions of the component; and
determining a level of structural integrity of the component based on said comparing.

2. The method of claim 1, wherein the component is a first type of component, and further comprising:
receiving input information indicative of the component being the first type of component; and
selecting the stored data from stored data indicative of signals received from a plurality of different types of components; and wherein said selecting is based on the input information received.

3. The method of claim 1, wherein said receiving, said comparing and said determining are carried out by an RFID reader, and further comprising:
wirelessly activating the RFID tags by scanning the component with the RFID reader remote from the vehicle component, whereby the RFID tags are powered by the RFID reader to generate the signals received by the RFID reader.

4. The method of claim 1, wherein stored data indicative of one of said sets of signals corresponds with a preferred physical condition of the component.

5. The method of claim 1, wherein the component has layers of fiber-reinforced composite material and the RFID tags are dispensed in resin between the layers of the composite material such that the RFID tags are embedded in the component.

6. The method of claim 1, wherein the vehicle component has a joint bonded with adhesive and the RFID tags are dispensed in the adhesive at the joint such that the RFID tags are embedded in the component.

7. The method of claim 6, wherein the physical condition is an amount of coverage of the adhesive in the joint.

8. The method of claim 1, further comprising:
providing an output indicative of the physical condition determined.

9. A method of evaluating structural integrity of a component comprising:
scanning the component with a radio frequency identification (RFID) reader to activate RFID tags embedded in the component such that the RFID tags generate signals received by the RFID reader; and
determining further processing of the component according to a level of structural integrity of the component indicated by the RFID reader; wherein the RFID reader indicates a level of structural integrity by comparing the signals received from the activated RFID tags to stored data indicative of sets of signals that are correlated with different levels of structural integrity of the component.

10. The method of claim 9, wherein the component is a first type of component, and further comprising:
embedding RFID tags in multiple components of the first type such that the RFID tags are arranged in a substantially identical initial spatial arrangement in each of said components;
scanning one of said components of the first type when said RFID tags are in said initial spatial arrangement and storing data indicative of signals received from said RFID tags in said initial spatial arrangement to establish a baseline set of signals;
damaging each of said multiple components by a different respective amount to vary the spatial arrangement of the RFID tags;
scanning each of said damaged multiple components with the RFID reader to receive additional signals from each of said damaged components; and
storing data indicative of the additional signals received from each of said damaged components in a database such that the data stored corresponds with the different respective amounts of damage.

11. The method of claim 10, wherein the database further includes stored data indicative of sets of signals corresponding with different respective amounts of damage of different types of components, and further comprising:
selecting a setting of the RFID reader corresponding to the first type of component from a plurality of settings each corresponding with different types of components.

12. The method of claim 9, wherein the component is a first type of component having a joint bonded with adhesive; wherein the RFID tags are in the adhesive at the joint, and further comprising:
embedding RFID tags in multiple components of the first type such that the RFID tags are arranged in a different initial spatial arrangement in each of said components of the first type;
scanning each of said components of the first type; and
storing data indicative of signals received from said RFID tags in the multiple components of the first type to establish a database of sets of signals corresponding with the different spatial arrangements of the RFID tags.

13. The method of claim 9, wherein the component has layers of composite material, and further comprising:
dispensing the RFID tags in resin between the layers of the composite material.

14. The method of claim 9, wherein the component has a joint bonded with adhesive, and further comprising:
dispensing the RFID tags in the adhesive at the joint.

15. A system for evaluating structural integrity of a vehicle component comprising:
a vehicle component having radio frequency identification (RFID) tags embedded within the vehicle component; wherein each RFID tag is configured to emit a signal indicative of a respective position of the RFID tag within the vehicle component; and
an RFID reader configured to wirelessly activate the RFID tags and having a processor configured to:
compare the signals received to stored data indicative of sets of signals that are correlated with different physical conditions of the vehicle component; and
determine a level of structural integrity of the vehicle component based on comparing the signals received to the stored data.

16. The system of claim 15, wherein the vehicle component has layers of composite material and the RFID tags are dispensed in resin between the layers of the composite material.

17. The system of claim 15, wherein the vehicle component has a joint bonded with adhesive and the RFID tags are dispensed in the adhesive at the joint.

18. The system of claim 15, wherein vehicle component is a first type of vehicle component; and wherein the RFID reader has:
a memory with a database of data indicative of the sets of signals for the first type of vehicle components and data indicative of additional sets of signals for other types of vehicle components having embedded RFID tags; wherein the data indicative of additional sets of signals is correlated with different levels of structural integrity of the respective other types of vehicle components; and
an input mechanism configured to receive input information indicative of the vehicle component being of the first type.
